(19) United States
(12) Patent Application Publication
(10) Pub. No.: US 2004/0153773 A1
(43) Pub. Date: Aug. 5, 2004

(54) Diagnosing faults in electronic machines

(76) Inventors: Arthur Cheumin Woo, Bristol (GB); Jeffrey S. McAllister, Boise, ID (US); Ian Russell, Wales (GB)

Correspondence Address: HEWLETT-PACKARD COMPANY, Intellectual Property Administration, P.O. Box 272400, Fort Collins, CO, 80527-2400, US

(21) Appl. No.: 10/315,107

(22) Filed: Dec. 10, 2002

(51) Int. Cl. H04L 1/22

(52) U.S. Cl. 714/25

(57) ABSTRACT

A diagnostic data acquiring device forms a data connection with an apparatus. The diagnostic data acquiring device includes data acquisition circuitry and a power source to power the data acquisition circuitry. The data acquisition circuitry receives data from the apparatus and causes the data to be stored. The device further includes power transfer circuitry adapted, to provide power to the apparatus from which the device is to acquire data.

### BACKGROUND OF THE INVENTION

The present invention relates to diagnosing faults in electronic machines. More particularly, the present invention relates to diagnosing faults in a diagnostic data acquiring device. Furthermore, the present invention relates to a combination of a diagnostic data acquiring device and a receiver. Still furthermore, the present invention relates to an apparatus to be diagnosed capable of transferring diagnostic data to a diagnostic data acquiring device. In addition, the present invention relates to a method of diagnosing an electrical apparatus. Lastly, the present invention relates to a machine readable medium containing instructions to cause an electrical apparatus to communicate with a diagnostic data acquiring device in response to being programmed into the electrical apparatus.

This invention is particularly applicable to tape drives and will be described in relation thereto, although it does have wider applicability as will also be explained herein. Tape drives for computer systems are used to back up data, which it will be appreciated, are sometimes more valuable than the computer equipment holding the data. Therefore, it is important to know when a tape drive is malfunctioning and also how it is malfunctioning.

It is not unknown for a tape drive to be returned to its manufacturer for repair only for it to be ascertained that the tape drive is in fact functioning correctly with the apparent malfunction that caused the drive to be returned being located elsewhere, or not in fact being a fault in the tape drive. Such situations are inconvenient for both the tape drive owner and the tape drive manufacturer, who are both likely to incur unnecessary expense if a drive is returned needlessly.

### SUMMARY OF THE INVENTION

According to a first aspect of the invention there is provided a diagnostic data acquiring device to form a data connection with an apparatus, the diagnostic data acquiring device comprising data acquisition circuitry and a power source for powering the data acquisition circuitry, the data acquisition circuitry to receive data from the apparatus and to store said data. The device further includes power transfer circuitry adapted to provide power to the apparatus from which the device is to acquire data.

Conveniently, the power source is arranged to power at least a portion of the apparatus (e.g.—diagnostic data memory circuits, or the electromechanical components of a tape drive, or other portions of a tape drive). Powering the apparatus in this manner is advantageous because it allows a diagnostic test to be performed on the apparatus even if portions of it are not receiving power from the apparatus itself. For example, if a fault in the apparatus has caused power to be cut from operative components of the apparatus.

It will be appreciated that the term ‘diagnostic data acquiring device’ is used herein to describe any device capable of receiving, storing and/or transmitting diagnostic data from an apparatus. It includes devices that do not execute or instruct an apparatus to execute diagnostic routines thereupon but merely collect previously acquired diagnostic data, and it also includes devices that do execute or instruct an apparatus to execute diagnostic routines thereupon and which collect the results of the diagnostic routines, and it also includes those devices which execute diagnostic routines or instruct an apparatus to execute diagnostic routines and which cause the results of the diagnostic routines to be stored off the device.

The power source can comprise a battery, a fuel cell, or the like, or can comprise a power connection to receive power from a source external to the device, e.g. an inductive power coupling, a terminal or terminals to which power leads may connect, wireless power transfer/power acceptance structures or any other suitable power connection or coupling arrangement.

Preferably, the device is portable, and most preferably is capable of fitting within a user's hand. Such an arrangement is convenient because it allows the device to be readily taken to remote sites and used to diagnose equipment on site rather than having to return the apparatus to a location where the test equipment is situated.

The device conveniently comprises a data memory in the form of a data storage device, for storing data received from the apparatus and most preferably, the data memory (or data storage device) comprises a non-volatile memory. The data memory can be an EEPROM, which may form a cartridge memory. Such an arrangement is convenient because it allows the data received from the apparatus to be readily obtained and stored. In arrangements such as a tape drive, it would allow the device to be removed from the tape drive without the data being lost. The data memory could of course comprise a hard disk drive, or the like.

The device can have a processor programmed to analyze data acquired by said data acquisition circuitry. Preferably, the processor comprises a diagnostic processor adapted to perform at least ones and possibly more, diagnostic operations on acquired data, and to output a signal indicative of a kind or nature of a fault of the apparatus.

The processor can be capable of performing diagnostic routines on the acquired data, for example, those routines that are within the processing power of said processor. The device also preferably has a processor memory. Simple diagnostic routines can also comprise those routines that can be performed satisfactorily with the limited amount of usable processor memory available to the processor. The device can have a telecommunication capability adapted to remotely communicate some or all acquired data and/or diagnosed faults.

Thus, the processor can be programmed to perform some diagnostic routines on acquired data and to remotely communicate at least some acquired data to another associated but remote processor for storage and/or processing by the associated remote processor.

Of course, the device can perform all of the processing necessary for diagnostic testing therein.

In some embodiments, the communication ability of the device comprises a transmitter arranged to transmit data received from the apparatus to a separate, or remote, location. Such an arrangement may be particularly convenient in situations in which the physical dimensions of the device are too small to contain any, or very much, memory, or the like.

The transmitter can be arranged to transmit data received from the apparatus across a physical connection to a remote location (such as a wire, a ribbon cable, cable, or the like), or can be arranged to transmit data received from the apparatus across a wireless connection.

The apparatus can comprise a tape drive and the device may have a cross section substantially the same as a tape cassette so that it can be inserted into the tape drive. Such an arrangement is convenient because it provides a convenient sized device, which is easily portable.

An identity indicator for identifying the device can be provided on the device, preferably on an external wall thereof. The identity indicator can be arranged such that it can be read by a cartridge memory (CM) interface of a tape drive. Such an arrangement is convenient because it allows the device to be inserted into a tape drive and recognized by the tape drive as being a diagnostic device. Such recognition can enable the production of diagnostic data by the apparatus and/or its transmission to the device. It will be appreciated that the identity indicator can be inside the device and that it can be read from outside of the device. The identity indicator can be mechanical, for example, a protrusion or recess which co-operates with a complementary formation in the apparatus to be diagnosed, or it can be non-mechanical, e.g. an infrared or other wireless link, or a wired/mating electrical contact link, which enables the identity of the device to be transmitted to the apparatus.

In one embodiment, the device has a length such that it protrudes from the tape drive in response to being substantially fully received by the tape drive. Such an arrangement can allow the device to be removed more easily than if the device were to be completely received within the tape drive.

In other embodiments, the device can be arranged such that it is not fully received by the tape drive. The tape drive can be arranged to identify that a diagnostic device has been inserted thereinto, generally by reading the identity indicator, and thereafter not fully insert the device.

Having the device protrude from the apparatus is particularly convenient in embodiments in which the apparatus comprises a tape drive that forms part of a tape library. In such arrangements, tapes are often inserted using robot arms and unless the device protrudes from the tape drive, it can be hard, if not impossible, for the robot arm to retrieve the device from the apparatus. The protrusion of the device from the tape drive also reduces the power required from the device's power source as the device can be manually removed from the tape drive without having to actuate the tape drive's eject mechanism.

It will be appreciated that in alternative embodiments the tape can be fully inserted into the tape drive in the conventional manner, particularly where it is desired to test the tape drives mechanical systems, for example, motor operation, or eject mechanism.

Conveniently, the device is arranged to be received in a receiving unit of the apparatus for electrically connecting to the diagnostic device.

The device can comprise a display for displaying, or presenting, information to a user thereof. The display can be arranged to display the status of the device. Additionally, or alternatively, the display can be arranged to display the results of an analysis performed on data received by the device from the apparatus. The display can comprise at least one LED, an LCD, a mechanical indicator, or any other suitable device. The display can also not be provided actually on the device that is inserted into the apparatus, but instead the device can communicate with an associated display. The display can also be an audio information-presenter (e.g. a loudspeaker, possibly capable of voice synthesis, or it can be a simpler audio device, such as a piezo-electric device or “beeper” capable of making a more limited range of noises (or only one tone), or other audio device).

In some embodiments, the device can be arranged to download trace logs from the apparatus with which it has a data connection. The trace logs can be stored in a memory of the apparatus, which can comprise a non-volatile memory, a hard drive, or the like. The trace logs can include information such as one or more of: type of tape that has been used in the drive, work cycle of the drive (constant operation or only occasional operation), temperature, humidity, airflow characteristics, warranty status of the drive, firmware decision tree results, error rate statistics of the drive, and drive hardware self-test results.

According to a second aspect of the invention, there is provided a combination of a diagnostic data acquiring device and a receiver, the diagnostic data acquiring device to form a data connection with an apparatus to be diagnosed, and comprising data acquisition circuitry and a power source for powering the data acquisition circuitry and at least partially powering the apparatus to which the device is to be connected, the data acquisition circuitry to receive data from the apparatus and to store the data, and the receiver being arranged to receive the diagnostic data acquiring device and to electrically connect thereto such that the diagnostic data acquiring device receives power therefrom.

The receiver can comprise a docking station, a cradle, or the like, and can be similar to those provided with Personal Digital Assistants (PDAs), as will be readily appreciated by a person skilled in the art. The receiver can comprise a receiving station that normally receives a machine-readable data carrier, such as a tape cassette, a hard or floppy magnetic disc, or an optical disc.

The device can be arranged to convey power to or from the receiver. Such an arrangement is convenient because it may allow the power source to be recharged.

Further, the device can be arranged to transfer data to said receiver. Such an arrangement is convenient as it can allow data to be downloaded from the device for later analysis.

Conveniently, the receiver is arranged to be connected to a processing apparatus, such as a computer, or the like. Such an arrangement is advantageous because it can facilitate the analysis of the data in order to diagnose the functionality of the apparatus from which the data originated.

According to a third aspect of the invention, there is provided a combination of a diagnostic data acquiring device to form a data connection with an apparatus, and an apparatus with which the device is capable of forming the data connection, wherein the device comprises data acquisition circuitry, a power source for powering the data acquisition circuitry, and for providing power to the apparatus, and power transfer circuitry adapted to transfer power from the power source to the apparatus, the data acquisition circuitry to receive data from the apparatus and to store the data, and the apparatus having power acceptance circuitry adapted to receive power from the power transfer circuitry, and being arranged to pass the data to said diagnostic data acquiring device.

The power source can comprise a battery, and/or terminals to which an external source of power can be connected.

Conveniently, the apparatus comprises a tape drive and the diagnostic data acquiring device conveniently has roughly the same cross section as a tape for use in the tape drive so that it can be received within the tape drive.

Further, the length of the device is conveniently such that it protrudes from the tape drive in response to being fully inserted thereinto. Such an arrangement allows the tape to be readily removed from the tape drive. Having the device protrude from the apparatus is particularly convenient in embodiments in which the apparatus comprises a tape drive that forms part of a tape library. In such arrangements, tapes are often inserted using robot arms and unless the device protrudes from the tape drive, it can be hard, if not impossible, for the robot arm to retrieve the device from the apparatus.

In one embodiment, the device comprises at least a portion that is insertable into the apparatus, and in fact, the device can be arranged so as to be substantially wholly insertable into the apparatus. Preferably, the arrangement is such that it allows electrical connections to be made between the device and the apparatus, which allows the data to be received from the apparatus.

Alternatively, the data may be received from the apparatus via a wireless connection. The wireless connection may be any one of the following: an Infrared (I.R.) link, a Bluetooth link, an IEEE 802.11 link, or any other suitable arrangement for the wireless transfer of data. Such arrangements are advantageous because they can simplify the connection of the device to the apparatus, and the precise location of the device relative to the apparatus is not critical to effective data transfer (commands from the device to the apparatus, or data from the apparatus to the device).

Conveniently, the power source is capable of powering the apparatus. Preferably, the power source is capable of providing power to the apparatus sufficient to enable the data to be transferred to the device. Such an arrangement is convenient because it helps to reduce the capacity of the power source required in the device. The skilled person will appreciate that certain apparatus contains electromechanical components and should these need to be powered by the power source, then the capacity of the power source can in some embodiments be sufficient to do this.

The device can be arranged to download the contents of a memory of the apparatus, and the memory contents as such may constitute the data that is received from the apparatus. For example, the apparatus can have a fault log, or usage history, which can be of value for fault diagnosis, and which can be downloaded.

In some embodiments, processing circuitry is provided in the device to analyze data received from the apparatus in order to diagnose the apparatus from which the data originated. Such an arrangement is convenient because it allows analysis to be performed while the device is in communication with the apparatus.

By “circuitry” it will be understood that much, or all, of the circuitry can be within a microprocessor.

In other embodiments, the processor can be arranged to perform no analysis, or limited analysis and can be arranged to cause the acquired data to be stored and/or communicated to an external analyzer. Such an arrangement is convenient because it reduces the computing power and computing memory required by the processing circuitry within the device. Furthermore, reducing the electrical power requirements of the device reduces the necessary capacity of the power source, and may reduce the need for cooling and also may reduce the cost of the device.

According to a fourth aspect of the invention, there is provided a method of diagnosing an electrical apparatus comprising: making a data connection with the apparatus with a diagnostic data acquiring device; providing power to the apparatus through the device; making a data connection between the apparatus and the device; and downloading data from the apparatus.

Such an arrangement is convenient because it allows electrical apparatus that is apparently faulty to be diagnosed and the device provides power to the apparatus, reducing the likelihood of the apparatus being unable to download data due to a power supply failure.

The downloaded data can be stored in a memory of the device and/or it can be communicated from the device to a remote diagnostic processor.

The device can perform a diagnostic process on said data.

In one embodiment, the apparatus is a tape drive and the method comprises diagnosing a tape drive.

The method can comprise inserting the device into a receiving station of the apparatus, which receiving station normally receives a machine-readable data carrier. The normally received machine-readable data carrier can be a tape, hard disc, floppy disc, optical disc, or removable solid-state device.

The method can comprise dimensioning the diagnostic device so that it can be received within a tape drive, and inserting said device into said tape drive. The method can comprise ensuring that the device has roughly the same cross section as a tape.

Conveniently, the method comprises inserting the device into the tape drive, making a data connection between the device and the tape drive, and downloading information from the tape drive, preferably to the device. Such an arrangement is convenient because it will facilitate operators/engineers to determine whether their tape drives are faulty before taking further steps. Providing a device that fits within the tape drive can provide for convenient, and possible intuitive, operation thereof.

According to a fifth aspect of the invention, there is provided an apparatus capable of receiving a diagnostic data acquiring device according to the first aspect of the invention wherein the apparatus is arranged to download diagnostic data to the device in response to a prompt therefrom and wherein the apparatus is arranged to accept power from the diagnostic data acquiring device.

The apparatus can have electrical circuitry adapted to convey power acquired from said device to electromechanical components of said device. The apparatus can have one or more electrical contact adapted to contact a complementary electrical contact on the device to convey power to such apparatus. Power can be conveyed wirelessly (e.g. by inductive power transfer).

In one embodiment, the apparatus comprises a tape drive.

The apparatus can be arranged to accept power from the diagnostic device. Such an arrangement is convenient in situations in which power has been lost to the device and power from the device can then allow the required data to perform diagnosis of the apparatus to be obtained.

Conveniently, the apparatus is arranged such that it can determine that a diagnostic device has been inserted thereinto. This is advantageous because code running on the apparatus may then be able to act accordingly, perhaps entering a mode allowing the diagnostic device to access data within the apparatus.

According to a sixth aspect of the invention, there is provided a machine readable medium containing instructions which, in response to being programmed into the electrical apparatus, cause the electrical apparatus to communicate with a diagnostic device and to provide power to the apparatus through the device and to download diagnostic data from the apparatus to the device.

The instructions can comprise what is commonly referred to as a flash upgrade.

The computer readable medium can comprise any one of the following: a floppy disk, a CDROM, a DVD ROM/RAM (including +RW/−RW), a hard drive, a non-volatile memory device, any form of magneto-optical disk, a transmitted signal (including an internet download, an ftp transfer, or the like) a wire, or any other medium capable of holding computer readable information.

According to a seventh aspect of the present invention, there is provided a diagnostic data acquiring device to form a data connection with a tape drive, the diagnostic data acquiring device comprising: data acquisition circuitry; a power supply to power the data acquisition circuitry, and power transfer circuitry; the data acquisition circuitry to receive data from the tape drive and to store the data; the tape drive having a read and/or a write head provided at a tape cassette receiving station, the receiving station being arranged to removably receive a tape cassette; and the device being arranged to be removably inserted into the receiving station, and the power supply being arranged to, at least partially, power the tape drive via the power transfer circuitry.

According to an eighth aspect of the present invention, there is provided a combination of a diagnostic data acquiring cassette and a docking station, the diagnostic data acquiring device to form a data connection with a tape drive to be diagnosed, and comprising: data acquisition circuitry; a power supply to power the data acquisition circuitry, and a power transfer connection adapted to provide power to a tape drive; the data acquisition circuitry to receive data from the tape drive and to store the data, and the docking station being arranged to receive the diagnostic data acquiring device and electrically connect thereto so as to receive the data therefrom.

According to a ninth aspect of the present invention, there is provided a combination of a diagnostic data acquiring cassette to form a data connection with a tape drive, and a tape drive with which the diagnostic data acquiring cassette is forming the data connection, the tape drive having power acquiring circuitry adapted to take power from the cassette, and wherein the diagnostic data acquiring cassette comprises: data acquisition circuitry; power transfer circuitry to transfer power to the tape drive, and a power supply to provide power to the tape drive, the data acquisition circuitry to receive data from the tape drive and to store the data, and the tape drive being arranged to pass data to the diagnostic data acquiring cassette.

According to a tenth aspect of the present invention, there is provided method of diagnosing a tape drive comprising providing a diagnostic cassette to make a data connection with the tape drive comprising: inserting the diagnostic data acquiring cassette into the tape drive; making a data connection between the diagnostic data acquiring cassette and the tape drive; downloading information from the tape drive; and providing power to the tape drive via said cassette.

According to an eleventh aspect of the present invention, there is provided software which, in response to being run upon data acquisition circuitry of a diagnostic data acquiring device having a data connection with an apparatus, causes the diagnostic data acquiring device to issue a prompt to the apparatus to download diagnostic data to the diagnostic data acquiring device via the data connection, the diagnostic data acquiring device having an internal power supply for the data acquisition circuitry.

Diagnostic data can be routed to a remote data analysis unit via an output of said diagnostic data acquiring device. Alternatively, or additionally, the said data acquisition circuitry can analyze the diagnostic data. The diagnostic data can be stored in either of a storage memory device or data acquisition circuitry memory.

According to another aspect, the invention comprises a diagnostic data acquiring device to form a data connection with an apparatus, the diagnostic data acquiring device comprising data acquisition circuitry and a power source to power the data acquisition circuitry, the data acquisition circuitry to receive data from the apparatus and to store the data.

In the aspect of the invention noted above, there is no requirement for the device to transfer power to the apparatus to be diagnosed. In many embodiments, power can be transferred, but it is not essential in this aspect of the invention.

The device, which is commonly an insertable device - insertable into an aperture of the apparatus to be diagnosed (e.g. data writer/data reader aperture) can be adapted to cause the transfer of diagnostic data from said apparatus. The device can be adapted to be identified by the apparatus as a diagnostic data acquiring device prior to the transfer of diagnostic data to said device. Identification of the device as an appropriate diagnostic data acquiring device suitable to have diagnostic data downloaded to it can be achieved a mechanical interaction between the device and the apparatus and/or communication of an identity code or label via an appropriate communications link (e.g. wireless link, or via wired/contacting electrical connections). The device can have a power transfer unit adapted to transfer power to the apparatus, and the power transfer unit can be adapted to provide power to at least one electronic circuit of the apparatus, or to provide power to an electromechanical component of the apparatus, or both. It will be appreciated that less power can be transferred to the apparatus if only electronic circuitry is to be powered (e.g. to provide enough power to cause a download of data from a data store).

The device of the above-noted aspect of the invention, or the device of other aspects of the invention, can have a diagnostic processor adapted to process diagnostic data acquired from the apparatus and to identify at least some faults of the apparatus from diagnostic processing of the diagnostic data. The device can be adapted to indicate that its diagnostic processor has made no diagnosis of an evaluated fault in the apparatus.

The device can be adapted to communicate acquired diagnostic data to another remote processor for further analysis. The processor device can be configured to assess acquired diagnostic data to determine if the apparatus has one of a restricted preset group of faults.

The device can be capable of forming a data connection with the apparatus in response to being only partially inserted therein.

According to another aspect, the invention comprises a diagnostic data acquiring device comprising a cartridge to form a data connection with an apparatus into which the cartridge is to be inserted, the cartridge comprising data acquisition circuitry to receive diagnostic data from the apparatus in response to the cartridge being at least partially inserted in the apparatus and to store the received diagnostic data, the cartridge having an identity indicator to identify it to the apparatus as a diagnostic data acquiring cartridge capable of receiving diagnostic data.

A connection can be made between the data acquisition circuitry and complementary data-providing coupling by the act of at least partially inserting the cartridge into the apparatus.

According to another aspect, the invention comprises a method of diagnosing an electrical apparatus having a read and/or write station, the method comprising providing a diagnostic data acquiring cartridge to make a data connection with the apparatus, inserting the cartridge into the apparatus at the station, making the data connection between the apparatus and the device, and downloading data from the apparatus in order that the data can be analyzed.

According to another aspect, the invention comprises a machine readable data reader and/or machine writable data writer apparatus having a read and/or write station adapted to receive an insertable and removable machine readable and/or writable data carrier, the apparatus having a processor adapted to perform a diagnostic data obtaining operation to obtain diagnostic data capable of being analyzed to determine the presence or absence of at least some faults of the apparatus; and the apparatus having a diagnostic data-acquiring device identifier to identify the presence of a diagnostic data-acquiring device at the station, the diagnostic data-acquiring device to receive diagnostic data obtained by the processor; and diagnostic data transfer circuitry adapted to transfer obtained diagnostic data to the diagnostic data-acquiring device in response to the device being in situ at the station; and wherein the processor recognizes an operative presence of a diagnostic data-acquiring device at the station and causes diagnostic data to be acquired by the device via the transfer circuitry.

According to another aspect, the invention comprises a method of reducing the number of tape drives that are removed from their site of use for fault diagnosis comprising inserting a diagnostic data acquiring cartridge into the tape drive, downloading fault diagnostic data to the cartridge, and diagnosing the diagnostic data at the site of the tape drive.

According to another aspect of the present invention, there is provided a combination of a diagnostic data acquiring device and a receiver, the diagnostic data acquiring device to form a data connection with an apparatus to be diagnosed, and comprising data acquisition circuitry and a power source to power the data acquisition circuitry and the data acquisition circuitry to receive data from the apparatus and to store the data, and the receiver being arranged to receive the diagnostic data acquiring device and electrically connect thereto such that the diagnostic data acquiring device receives power therefrom.

According to yet a further aspect of the present invention, there is provided a combination of a diagnostic data acquiring device to form a data connection with an apparatus, and an apparatus with which the device forms the data connection, wherein the device comprises data acquisition circuitry and a power source to power the data acquisition circuitry, the data acquisition circuitry to receive data from the apparatus and to store the data and the apparatus being arranged to pass data to the diagnostic data acquiring device.

### BRIEF DESCRIPTION OF THE DRAWINGS

In order that the invention may be understood, there now follows, by way of non-limiting example only, a detailed description of some embodiments of the invention with reference to the accompanying drawings of which:

FIG. 1 is a perspective drawing of a tape drive having a slot carrying a diagnostic data acquiring device according to one aspect of the present invention;

FIG. 2 is a block diagram of the components within the diagnostic data acquiring device shown in FIG. 1;

FIG. 3 is a schematic sectional view through the diagnostic device and tape drive of FIG. 1, with the diagnostic data acquiring device inserted in the tape drive;

FIG. 4 is a perspective view of a docking station for a diagnostic data acquiring device connected to a computer;

FIG. 5 is a flowchart of the steps involved in using embodiment of the diagnostic data acquiring device;

FIG. 6 is a schematic view of a rear face of the diagnostic data acquiring device of FIG. 1;

FIG. 7 is a schematic view of a front face of the diagnostic data acquiring device of FIG. 1;

FIG. 8 is a schematic perspective view of a front face of another embodiment of a diagnostic data acquiring device;

FIG. 9 is a schematic perspective view of a diagnostic data acquiring device and a mobile telephone;

FIG. 10 is a schematic perspective view of a diagnostic data acquiring device and a digital camera;

FIG. 11 is a schematic perspective view of a diagnostic data acquiring device and a printer; and

FIGS. 12a to 12g are schematic representations of various embodiments of diagnostic data acquiring devices.

### DETAILED DESCRIPTION

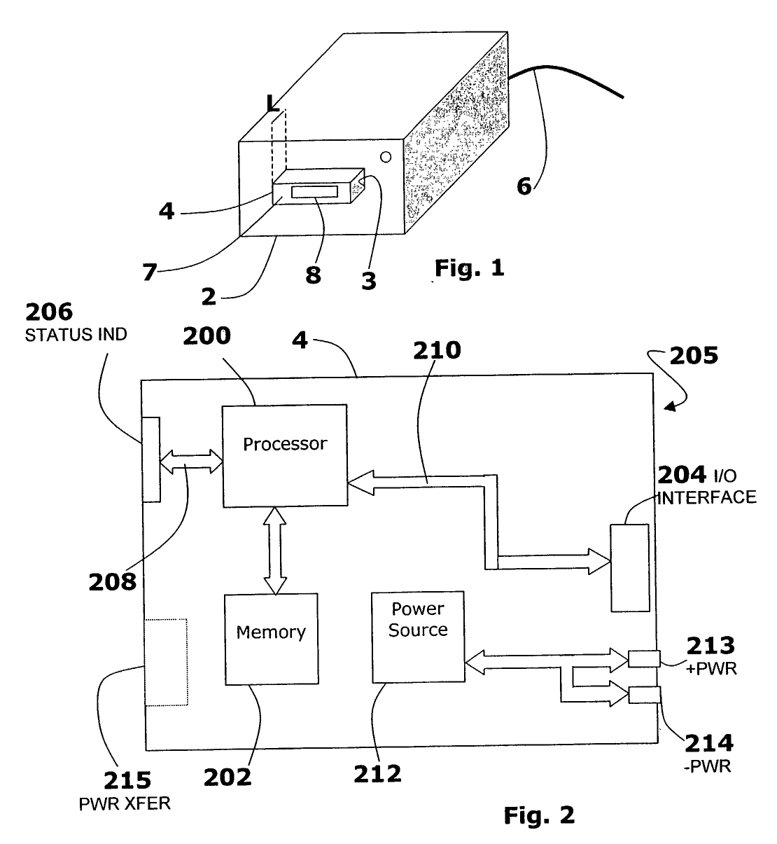

Some embodiments of the invention are described primarily in relation to a tape drive, although as will be appreciated from the following description the invention has wider applicability and can be used in many other forms of apparatus. FIG. 1 is a perspective view of typical tape drive 2 in which a diagnostic device 4 according to an embodiment of the present invention has been inserted into the slot 3 for receiving a tape cassette or cartridge. As is common practice, the tape drive 2 is connected to a remote device (such as a computer) via the cable 6. A front face 7 of the diagnostic device includes a display status indicator 8.

The components of the diagnostic device 4 shown in FIG. 1. FIG. 2 is a block diagram including a processor 200 and associated memory 202, typically an EEPROM forming a cartridge memory (CM) are provided and arranged to control the functionality of the diagnostic device 4 as will be described hereinafter. The processor 200 connects to a data input/output interface 204 and a status indicator 206 through two busses 208, 210. The input/output interface 204 is provided on a back face 205 of the device and provides a connection to the processor 200 from the outside of the device. The diagnostic device 4 is also provided with a power source 212, which not only powers the components of the diagnostic device (connections not shown), but also connects to a positive 213 and a negative 214 power terminal which are accessible on the outside of the diagnostic device 4. A power transfer port 215 may or may not be provided to allow power to be transmitted to the device 205. It will be appreciated that in this embodiment the casing of the diagnostic device 4 is dimensioned so that it has substantially the same cross section as a tape used by the tape drive 2. However, the length of the diagnostic device 4 is such that it protrudes by a length L (as can be seen in FIG. 1) from the tape drive 2 in response to being fully inserted therein. The diagnostic device 4 is typically of a similar size to a tape cartridge, for example, a linear tape open (LTO) cartridge, 10.5 cm×10 cm. In the case of a videotape, the tape cartridge is typically 20 cm×12 cm×2 cm.

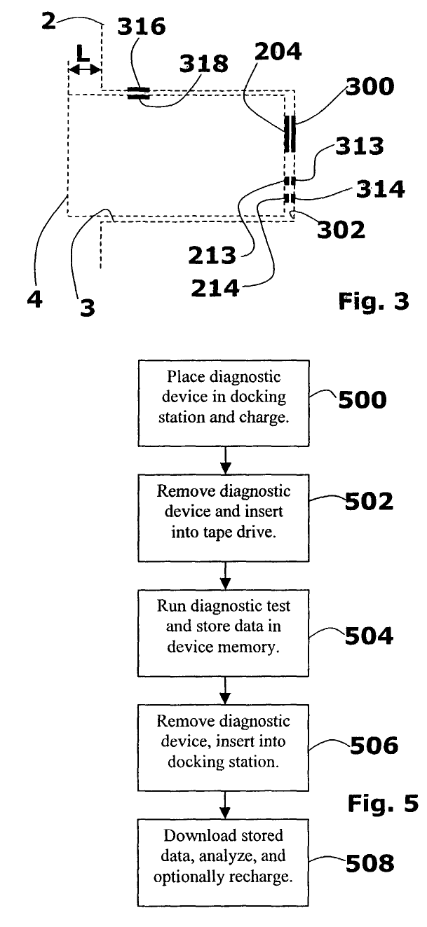

As can be seen from FIG. 3, in response to the diagnostic device 4 being inserted into the opening 3 in the tape drive 2, the input/output interface 204 of the diagnostic device connects to a complimentary input/output interface 300 on a rear face 302 of the opening 3. Further, the positive 213 and the negative 214 power terminals connect to complementary positive 313 and negative 314 power terminals of a rear face of the opening 3.

Further, as will be appreciated by a person skilled in the art, tape drives 2 generally have a CM interface 316 that allows the tape drive 2 to identify a tape that has been inserted thereinto. Tapes have a CM output that can be read by the CM interface 316. In the embodiment described herein the diagnostic device 4 has a CM output 318, or identity indicator that can be read by the CM interface 316 allowing the tape drive 4 to identify that it is a diagnostic device 4 that has been inserted thereinto. Generally, the CM interface 316 reads the CM output 318 in order to identify the unique identity that identifies the device 4 as a diagnostic device.

The diagnostic device 4 can be manually inserted into the opening 3 of the tape drive 2 and used to diagnose whether or not the tape drive is functioning correctly, or to diagnose faults that occur within the tape drive 2. As will be appreciated from FIGS. 2 and 3, the diagnostic device makes electrical contact with the tape drive (the positive power terminal 213 connects to the corresponding positive power terminal on the tape drive 313 and the negative power terminal 214 connects to the corresponding negative power terminal 314 on the tape drive). The power source 212 has sufficient capacity to power not only the components of the diagnostic device 4, but also to drive power into the tape drive 2 via the electrical contact therewith. In some embodiments, the diagnostic device 4 has a power connection thereto (shown in dotted outline in FIG. 2 and referenced 215) from an external power source in order to provide sufficient capacity. The CM interface 316 of the tape drive 2 identifies that a diagnostic device 4 has been inserted thereinto.

The diagnostic device 4 is also in data connection via the input/output interface 204 and it connection to the complementary interface 300 on the tape drive 2. Therefore, the processor 200 can cause signals to be transmitted into the circuitry of the tape drive 4 via the data connection and also receive responses caused by the signals.

Further, code running on the processor 200 and associated memory 202 is arranged to generate suitable signals for performing diagnostic testing on the tape drive 4 and to store the signals it receives in the memory 202. The memory 202 is of sufficient capacity to store the signals, typically having a capacity of at least a few megabytes. Further, the memory is preferably of a non-volatile variety so that the test results are not lost should the power source 212 fail. In one embodiment, the processor 200 causes the contents of non-volatile memory (typically EEPROMs) within the tape drive 2 to be copied into the memory 202 of the diagnostic device.

In one embodiment, the processor 200 does not perform analysis on the signals it receives from the data connection with the tape drive 4 and simply stores the signals (or a compressed, or otherwise processed, version of the signals) in the memory 202 for analysis at a later date. This has the advantage that the power of the processor 200 can be reduced, which in turn will reduce the power requirement placed upon the power source 212. However, it will be appreciated that in other embodiments, the processor may analyze the signals that it receives from the tape drive 4 and attempt to diagnose at least some faults within the tape drive 4 and possibly displays the results on the display.

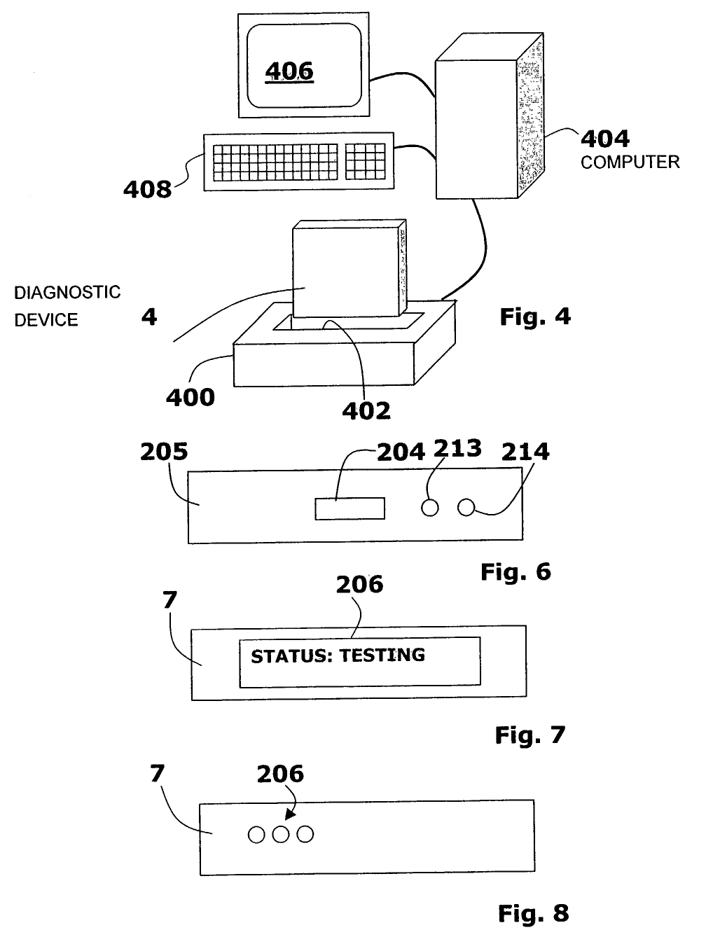

FIG. 4 is a view of the diagnostic device 4 in relation to a docking station 400, providing a receiver, arranged to receive the diagnostic device 4 in an opening 402 therein. Although not shown, the opening 402 has a data input/output interface complementary to that on the back face 205 of the diagnostic device 4 and also has positive and negative power terminals complementary to the positive 213 and negative power terminals 214 on the diagnostic device 4. Thus, in response to the diagnostic device being inserted into the opening 402, it is in both electrical connection (capable of receiving power via the positive 213 and negative 214 power terminals) and also in data connection therewith (capable of receiving data via the input/output interface 204).

Thus, the docking station 400 allows the device 4 to transmit data to a remote location. It would also be possible for the device 4 to communicate directly with a computer by connecting a cable (perhaps a USB, parallel, etc.) between the device 4 and the computer. It would also be possible to transmit data between the device 4 and the computer using a wireless link.

The docking station connects to a computer 404 that is shown having a Visual Display Unit (VDU) 406 and a keyboard 408. The connection to the computer 404 is shown via a cable, but can be via a wireless protocol such as Bluetooth, or IEEE 802.11.

The docking station can be used to recharge the diagnostic device 4, to download the signals stored in the memory 202 thereof, to provide new/updated code for the processor (to be stored in the non-volatile memory 202), or to perform diagnosis on data obtained by the diagnostic device, or the like. FIG. 5 is a flowchart of how it is envisaged the diagnostic device would be used.

The diagnostic device 4 is placed in the docking station 400 and the power source 212 is sufficiently charged to allow the subsequent testing to be performed. This is shown in the box 500.

Next, the diagnostic device 4 is removed from the docking station 400 and inserted into the tape drive 2 that is to be tested (as shown in box 502 of the flowchart).

Once the diagnostic device 4 has been inserted into the tape drive 2, the processor 200 begins transmitting signals into the tape drive 2 via input/output interface 204 in order to test the tape drive 2. Signals that are received back from the tape drive 2 are stored in the memory 202 for later analysis. This step in the method is shown in box 504 of the flowchart. The diagnostic device 4 may be able to determine automatically that it has been inserted into the tape drive 2 due to the establishment of a data connection through the input/output interface 204, or through use of the CM interface 316. However, in other embodiments, a user may initiate testing by pressing a button, switch, or the like on an exposed face of the diagnostic device 4.

Once the diagnostic testing has finished, the diagnostic device 4 is removed from the tape drive 2 and inserted again into the docking station 400, as shown in box 506 of the flowchart. The diagnostic device 4 may indicate that it has finished by way of the status indicator 206 on the front face thereof.

Once the diagnostic device 4 has been inserted into the docking station 400, data is downloaded from the memory 202 via the input/output interface 204 and fed to the computer 404. The device 4 can, optionally, be recharged from the docking station 400, possibly at this stage. This step in the method is shown in box 508 of the flowchart. The computer 404 can then be used to analyze the results and determine whether or not the tape drive has a fault, or whether it is functioning correctly.

It is envisaged that the device 4 could be used in the diagnosis of faults upon a number of tape drives prior to being reinserted into the docking station 400. Thus, data, obtained from each of the tape drives and stored in the memory 202, will typically be partitioned in order that data relating to each individual drive can be analyzed and/or uploaded onto a computer 404 separately.

This arrangement allows a field engineer to diagnose system related faults on-site. It is often the case that apparent system related faults are due to the users' set up. If this is the case, the engineer can avoid sending a device to a repair depot unnecessarily and can concentrate solving the customer's set up problem. In the case of a tape library, it would be usual to remove the tape drive from all interfaces prior to inserting the diagnostic device 4.

The input/output interface 204, positive power terminal 213, negative power terminal 214 can be clearly seen on the back face 205 of the diagnostic device in FIG. 6. Alternatively, the power terminals of the device 4 may be slots in the device 4 along which is guided in to the docking station 400 by complementary power rails in the docking station. It will be appreciated that the input/output interface may provide a physical connection between the diagnostic device 4 and the input/output interface 300 of the tape drive 2, or in alternative embodiments it may provide a wireless data connection. The skilled person will appreciate the applicable technologies can include any of the following: an IR connection, a Bluetooth connection, an IEEE 802.11 connection, or any other form of wireless protocol suitable for a short-range connection. Indeed, if such a wireless connection is possible, it may not be necessary to dimension the diagnostic device to fit within the opening 3 of the tape drive, so long as it can provide power to the apparatus/tape drive and so long as diagnosis occurs, or data collection for subsequent diagnosis occurs.

A first example of the status indicator 206 is shown on the front face 7 of the diagnostic device 4 in FIG. 7 and comprises an LCD display. The LCD is driven via appropriate controlling circuitry under the control of the processor 200 and can be used to display messages to a user of the device 4. In FIG. 7, the status indicator 206 is reporting the status that the processor 200 is performing testing on the tape drive 2.

An alternative embodiment of the status indicator 206 is shown in FIG. 8 and comprises a series of LED's mounted on the front face 7 (in the example, three are shown). The illumination of any one particular LED may indicate a particular status to a user. For example, the leftmost LED may indicate that the processor 200 is performing a text, the middle LED may indicate that the processor 200 has finished testing and the rightmost LED may indicate that an error has occurred.

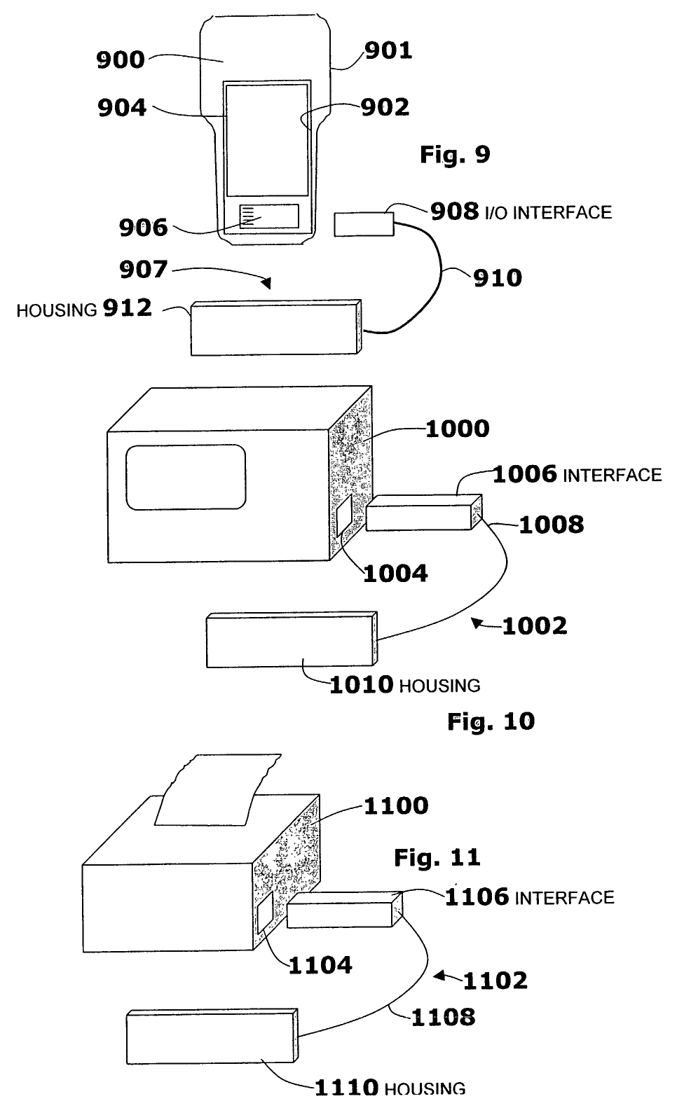

As discussed above, this invention may have wider applicability than diagnosing faults on tape drives. As shown in FIG. 9, a version may be provided that is capable of diagnosing faults in an apparatus such as mobile telephones. FIG. 9 shows a rear face 900 of a telephone 901 having a rear cover (not shown) removed exposing an opening 902 in which there is a battery 904 and a SIM card interface 906. In this embodiment, the diagnostic device 907 comprises an input/output interface 908 capable of making a data connection with the SIM card interface 906, a housing 912 containing the processor, memory and the like and a cable 910 linking the housing to the SIM card interface 906. In use, the embodiment shown in FIG. 9 is used much as described with reference to FIGS. 1 to 8. The diagnostic device 907 is typically of the same or similar dimensions to a SIM card, for example 2 cm×3 cm×0.5 cm.

FIG. 10 is a view of a further alternative embodiment in which the apparatus comprises a digital camera 1000 which is provided with a diagnostic device 1002. The digital camera 1000 is provided with a media slot 1004 that is arranged to receive a media on to which pictures taken by the camera can be stored. The skilled person will appreciate that the media can include: flash memory cards, PCMIA cards, memory sticks (particularly applicable to SONY products) and the like. The diagnostic device 1002 comprises a media slot interface 1006 and a housing 1010 connected to the media slot interface 1006 via a cable 1008. Again, the embodiment shown in FIG. 10 is used much in the same way as the embodiment described in relation to FIGS. 1 to 8.

FIG. 11 is a view of a further alternative embodiment in which the apparatus comprises a printer 1100 which is to be provided with a diagnostic device 1102. The printer 1100 is provided with a media slot 1104 which is arranged to receive a media on to which data, possibly images, to be printed by the printer are stored. The skilled person will appreciate that the media can include: flash memory cards, PCMIA cards, memory sticks (particularly applicable to SONY products) and the like. The diagnostic device 1002 comprises a media slot interface 1006 and a housing 1010 connected to the media slot interface 1006 via a cable 1008. Again, the embodiment shown in FIG. 11 is used much in the same way as the embodiment described in relation to FIGS. 1 to 8.

It will be appreciated that the embodiments described with reference to FIGS. 9 to 11 utilize devices that may be termed memory devices, SIM cards and media cards and thus can be considered to be memory devices of a similar fashion to the tape media described in relation to FIG. 1 to 8.

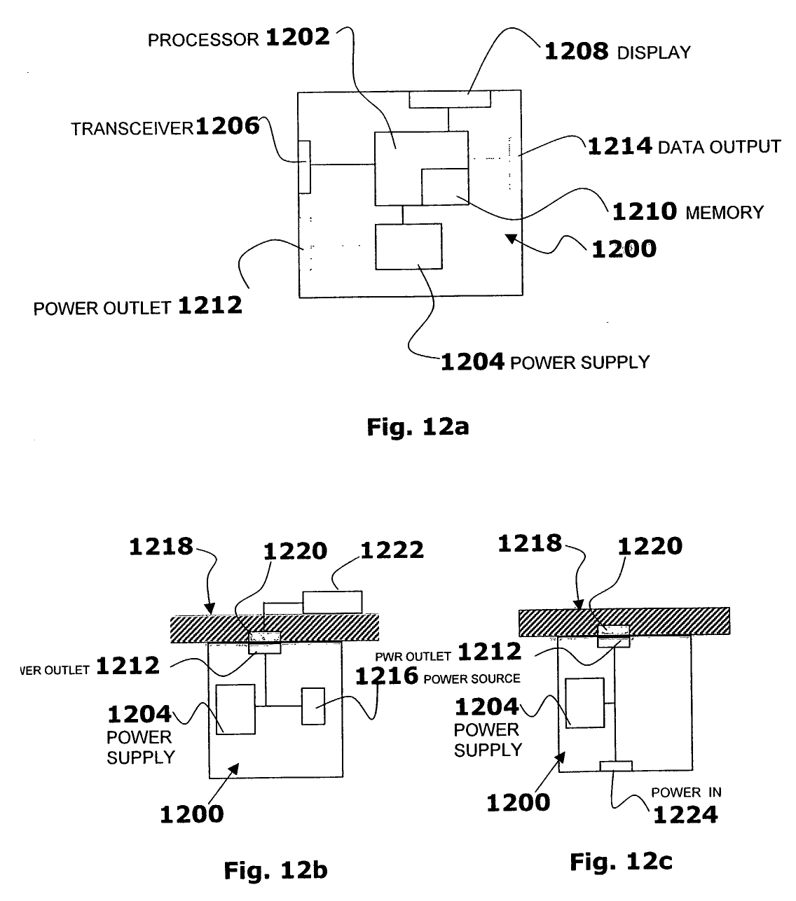

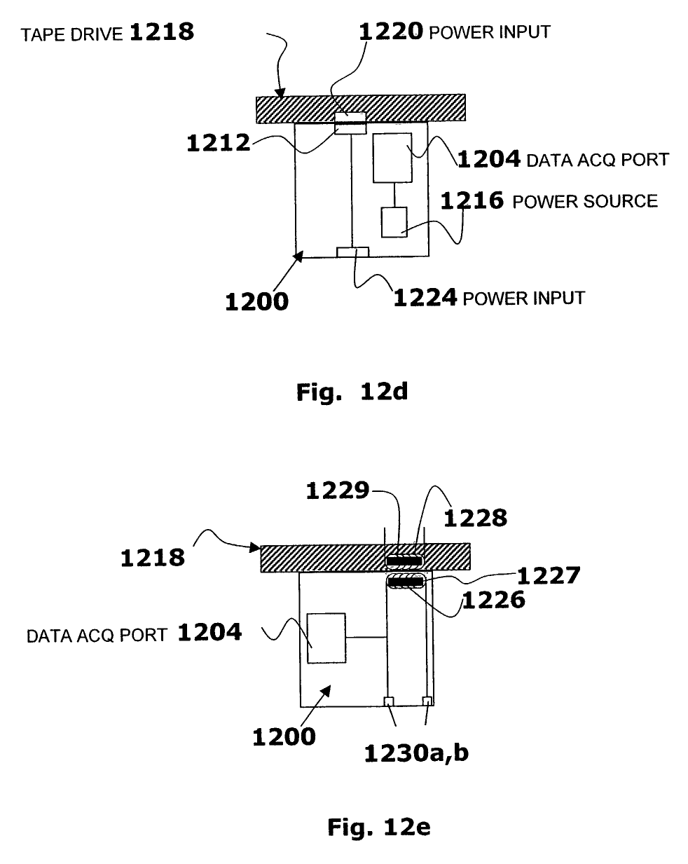

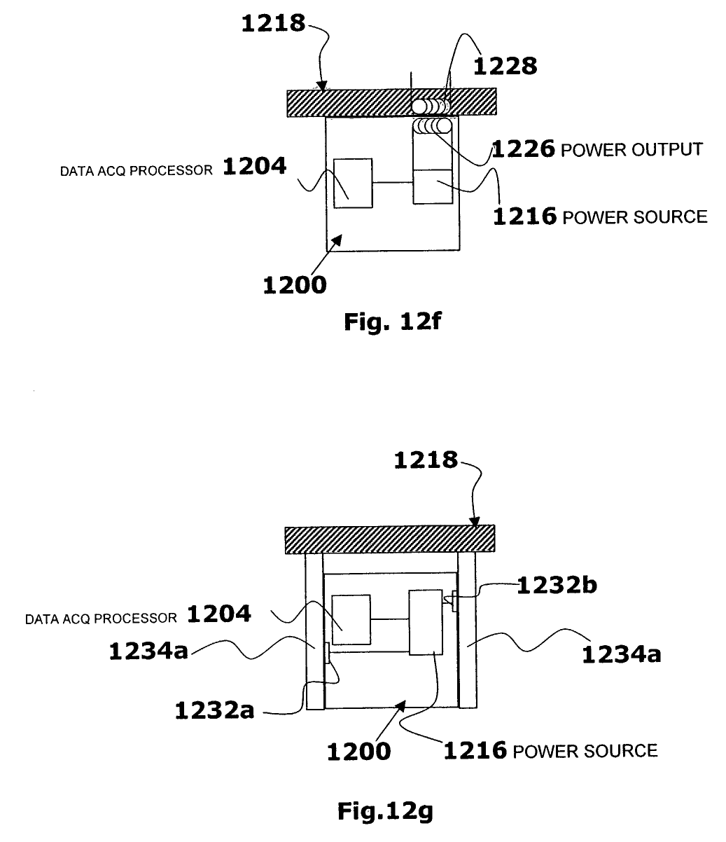

Referring now to FIG. 12a, a diagnostic data acquiring device 1200 comprises a processor 1202, a power supply 1204, an infrared transceiver 1206 and a display 1208. The processor 1202 has a processor memory 1210 associated with it and is powered by the power supply 1204. The infrared transceiver 1206 is arranged to communicate with a complimentary transceiver of a tape drive (not shown). The processor 1202 issues a command to the tape drive via the transceiver 1206 to download diagnostic data from the tape drive to the device 1200. The processor memory 1210 serves as a temporary store and buffer for the downloaded diagnostic data. The processor 1202 executes simple diagnostic routines upon the downloaded data and outputs a result via the display 1208. The result can be simply a pass/fail result or may include more detailed information.

Optionally, the device may include a power outlet 1212 that is arranged to be coupled to the tape drive, typically through locating pins of the tape drive or through a convenient surface of the tape drive that abuts the device 1200, in order to supply power to the tape drive from the power supply 1204. The power supply 1204 can supply sufficient power only for the tape drive to download data to the device, or it may supply sufficient power to drive mechanical systems of the tape drive if necessary. Additionally, the device 1200 may have a data output 1214 that outputs the downloaded data to an external data analysis unit, for example a PC, if high level diagnosis is required.

FIG. 12b is a view of a diagnostic data acquiring device 1200 having an internal power source 1216, typically a battery, that powers a data acquisition processor 1204 and a power transfer output 1212. The power output 1212 connects to a complimentary power input 1220 mounted on a tape drive 1218. The power input 1220 connects to an electromechanical drive circuitry 1222 of the tape drive 1218.

In FIG. 12c, a diagnostic data acquiring device 1200 has an external power input 1224 that connects directly with a power transfer output 1212, a data acquisition processor 1204 receives power from the power input 1224. The power output 1212 connects to a complimentary power input 1220 of a tape drive 1218 as described hereinbefore.

Referring now to FIG. 12d, a diagnostic data acquiring device 1200 has an external power input 1224 connected directly to a power transfer output 1212. The power output 1212 connects to a complimentary power input 1220 of a tape drive 1218 as described hereinbefore. A data acquisition processor 1204 of the device 1200 is powered from an internal power source 1216, usually a battery.

A data acquiring diagnostic device 1200, as shown in FIG. 12e, includes a data acquisition processor 1204, an inductive power output coupling 1226 having a ferrite core 1227 and power input ports 1230a,b. A tape drive 1218 has an inductive power input coupling 1228, having a ferrite core 1229, located adjacent the power output coupling 1226, in use, such that an a.c. voltage input across the input ports 1230a,b is coupled to into circuitry (not shown) of the tape drive 1218. The processor 1204 receives power from one of the input ports 1230a.

Referring now to FIG. 12f, a data acquiring diagnostic device 1200 comprises a data acquisition processor 1204, a power source 1216 and an inductive power output coupling 1226. A tape drive 1218 has an inductive power input coupling 1228 located adjacent the power output coupling 1226, in use, such that an a.c. voltage generated at the power source 1216 is coupled to into circuitry (not shown) of the tape drive 1218. The processor 1204 receives power from the power source 1216.

Referring now to FIG. 12g a data acquiring diagnostic device 1200 comprises a data acquisition processor 1204, a power source 1216 and power output couplings 1232a,b mounted on side walls of the device 1200. A tape drive 1218 has guide rails 1234a,b that guide the device 1200 into location, in use. The guide rails 1234a,b are conducting and connectd with respective power output couplings 1232a,b so as to allow the supply of power to the tape drive 1218 therethrough.

What is claimed is:

1. A diagnostic data acquiring device to form a data connection with an apparatus, the diagnostic data acquiring device comprising:
data acquisition circuitry, said data acquisition circuitry to receive data from the apparatus and to store said data;
a power source to power said data acquisition circuitry; and
power transfer circuitry adapted to provide power to the apparatus from which said device is to acquire data.

2. The device according to claim 1, wherein said device is arranged to be removably inserted into a data carrier receiving station of the apparatus, the apparatus having at least one of a read or a write head provided at the data carrier receiving station arranged to removably receive said data carrier.

3. The device according to claim 1, wherein said device forms a data connection with an apparatus comprising a tape drive.

4. The device according to claim 1, further comprising a data storage device, to store said data.

5. The device according to claim 1, wherein said power source is arranged to provide power to at least a portion of the apparatus.

6. The device according to claim 1, further comprising a transmitter arranged to transmit data received from the apparatus to a remote location.

7. The device according to claim 1, further comprising an identifier to identify the device.

8. The device according to claim 1, further comprising a display to display results of an analysis performed on said data received by the device to a user thereof.

9. The device according to claim 1, further comprising a receiver arranged to receive said data via a wireless connection.

10. A diagnostic data acquiring device receiver adapted to receive a diagnostic data acquiring device to form a data connection with an apparatus to be diagnosed, and comprising data acquisition circuitry and a power source to power said data acquisition circuitry and at least partially powering said apparatus to which said device is to be connected, said data acquisition circuitry to receive data from said apparatus and to store said data; said receiver being arranged to receive said diagnostic data acquiring device and electrically connect thereto such that said diagnostic data acquiring device receives power therefrom.

11. The receiver according to claim 10, wherein said receiver comprises a docking station and a cradle.

12. The receiver according to claim 10, wherein said receiver is arranged to receive transferred data from said device.

13. A combination of a diagnostic data acquiring device to form a data connection with an apparatus, and an apparatus with which said device is to form said data connection, wherein said device comprises data acquisition circuitry and a power source to power said data acquisition circuitry, and to provide power to said apparatus, and power transfer circuitry adapted to transfer power from said power source to said apparatus, said data acquisition circuitry to receive data from said apparatus and to store said data and said apparatus having power acceptance circuitry adapted to receive power from said power transfer circuitry, and to pass data to said diagnostic data acquiring device.

14. The combination according to claim 13, wherein said apparatus comprises a tape drive.

15. The combination according to claim 14, wherein said diagnostic data acquiring device has the same cross section as a tape arranged for use with said tape drive so that said device can be received within said tape drive.

16. The combination according to claim 13, wherein said device is arranged to download the contents of a memory of said apparatus and the memory contents constitutes said data received from said apparatus.

17. The combination according to claim 13, further comprising processing circuitry in said device, said processing circuitry being arranged to analyze data received from the apparatus in order to diagnose said apparatus from which said data originated.

18. The combination according to claim 13, wherein said power source powers at least a portion of said apparatus.

19. The combination according to claim 18, wherein said device provides power to said apparatus sufficient to enable said data to be transferred to said device.

20. A method of diagnosing an electrical apparatus comprising:
making a data connection with the apparatus with a diagnostic data acquiring device;
providing power to said apparatus through said device; and
downloading data from said apparatus to the device.

21. The method according to claim 20, wherein said apparatus is a tape drive.

22. The method according to claim 21, further comprising:
inserting said device into said tape drive;
making a data connection between said device and said tape drive in response to said device being at least partially inserted in said tape drive; and
downloading information from the tape drive to said device.

23. The apparatus according to claim 1, wherein the apparatus is arranged to accept power from said diagnostic data acquiring device.

24. The apparatus according to claim 23, wherein the apparatus comprises a tape drive.

25. The apparatus according to claim 23, wherein the apparatus is arranged to determine that a diagnostic device has been inserted thereinto.

26. A machine readable medium containing instructions which, in response to being programmed into said electrical apparatus, cause the electrical apparatus to:
communicate with a diagnostic data acquiring device; and to accept power from the device; and
to transfer diagnostic data to the device.

27. The machine readable medium according to claim 26, wherein the apparatus comprises a tape drive.

28. A diagnostic data acquiring device to form a data connection with an apparatus, the diagnostic data acquiring device comprising:
data acquisition circuitry;
a power source to power said data acquisition circuitry;
wherein said data acquisition circuitry receives data from the apparatus and stores said data.

29. A device according to claim 1, wherein said data comprises diagnostic data.

30. A device according to claim 1, wherein said device is adapted to be identified by said apparatus as a diagnostic data acquiring device prior to transfer of diagnostic data to said device.

31. The device according to claim 30, wherein said device has a mechanical identifier which is recognized by said apparatus, and a communications link identifier adapted to transmit an identifying signal to said apparatus which is recognized by said apparatus.

32. The device according to claim 1, wherein said power transfer circuitry is adapted to provide power to at least one electronic circuit of said apparatus.

33. The device according to claim 1, wherein said power transfer circuitry is adapted to provide power to at least one electromechanical component of said apparatus.

34. The device according to claim 1, wherein the device forms a data connection with said apparatus in response to being partially inserted therein, and the device transfers power to the apparatus in response to being partially inserted therein.

35. A diagnostic data acquiring device comprising a cartridge to form a data connection with an apparatus into which said cartridge is inserted, said cartridge comprising data acquisition circuitry to receive diagnostic data from said apparatus in response to said cartridge being at least partially inserted in said apparatus and to store received diagnostic data, said cartridge having an identifier to identify it to said apparatus as a diagnostic data acquiring cartridge capable of receiving diagnostic data.

36. The device according to claim 35, wherein said identifier is adapted to generate an identifier signal, via one of a mechanical link or a telecommunications link, to cause downloading of diagnostic data from said apparatus to said cartridge.

37. The device according to claim 1, wherein the device further comprises a diagnostic processor adapted to process diagnostic data acquired from said apparatus and to identify at least some faults of said apparatus from diagnostic processing of said diagnostic data.

38. The device according to claim 37, wherein the device indicates that no diagnosis of an evaluated fault of said apparatus has been made by its diagnostic processor processing said acquired diagnostic data.

39. The device according to claim 37, wherein the device is adapted to communicate said acquired diagnostic data to another remote processor for further analysis.

40. The device according to claim 37, wherein said processor is configured to assess said acquired diagnostic data to determine if said apparatus has one of a restricted preset group of faults.

41. A machine readable data reader/writer apparatus having at least one of a read and a write station adapted to receive an insertable and removable machine readable data carrier and a writable data carrier, said apparatus having a processor adapted to perform a diagnostic data obtaining operation to obtain diagnostic data capable of being analyzed to determine the presence or absence of at least some faults of said apparatus; and said apparatus having a diagnostic data-acquiring device identifier to identify the presence of a diagnostic data-acquiring device at said station, said diagnostic data-acquiring device to receive diagnostic data obtained by said processor; and diagnostic data transfer circuitry adapted to transfer obtained diagnostic data to said diagnostic data-acquiring device in response to said device being in situ at said station; wherein said processor recognizes an operative presence of a diagnostic data-acquiring device at said station and causes diagnostic data to be acquired by said device via said transfer circuitry.

42. The apparatus according to claim 41, further comprising an identifier signal receiver adapted to receive an identifying signal from said device identifying said device as capable of acquiring diagnostic data; wherein said receiver communicates the presence of said device to said processor.

43. The apparatus according to claim 42, wherein said receiver is from the group comprising a telecommunications receiver and a mechanical interconnection with said device.

44. The according to claim 41, wherein said processor is adapted to recognize a trigger initiation signal, generated in accordance with a suitable diagnostic data-acquiring device being present at said station, and to obtain and transfer to said device said diagnostic data in response to said initiation signal.

45. The apparatus according to claim 41, further comprising power acceptance circuitry to enable said apparatus to accept power from said device.

46. The apparatus according to claim 45, wherein said power acceptance circuitry is adapted to provide power to at least one selected from the group comprising an electromechanical component of said apparatus and an electronic component of said apparatus.

47. The apparatus according to claim 45, wherein said power acceptance circuitry is adapted to receive power from said device in response to said device being at least partially received into said station.

48. The apparatus according to claim 45, further comprising a tape drive.

49. A method of reducing the number of tape drives that are removed from their site of use for fault diagnosis, the method comprising inserting a diagnostic data acquiring cartridge into one of said tape drives, downloading fault diagnostic data to said diagnostic data acquiring cartridge, and diagnosing said diagnostic data at said site of said tape drive.

50. The method according to claim 49, further comprising using said cartridge to diagnose at least some faults.

51. The method according to claim 50, further comprising using a diagnostic capability built into said cartridge to perform a limited range of diagnostic checks, and having said cartridge check for faults within its capabilities, and upon said cartridge failing to diagnose the fault, one of either:
removing the tape drive off-site for further tests; or
transferring the diagnostic data from the cartridge to a diagnostic processor capable of performing a wider range of diagnostic tests and testing said data on-site with said diagnostic processor.

52. A method of diagnosing an electrical apparatus having a read/write station comprising providing a diagnostic data acquiring cartridge to a data connection with the apparatus, inserting the cartridge into said apparatus at said station, making said data connection between said apparatus and said device, downloading data from said apparatus in order that said data can be analyzed.
